(19) United States
(12) Patent Application Publication
(10) Pub. No.: US 2026/0130533 A1
(43) Pub. Date: May 14, 2026

(54) CUTTING BLADE FOR JUICER

(71) Applicant: NINGBO KEPO ELECTRONICS CO., LTD., NINGBO (CN)

(72) Inventors: YOUNG DO MIN, NOINGBO (CN); XINWEN JIANG, NINGBO (CN)

(73) Assignee: NINGBO KEPO ELECTRONICS CO., LTD., NINGBO (CN)

(21) Appl. No.: 19/381,013

(22) Filed: Nov. 6, 2025

(30) Foreign Application Priority Data
Nov. 13, 2024 (CN) 2024227647527

(51) Int. Cl. A47J 19/02

(52) U.S. Cl. CPC A47J 19/02

(57) ABSTRACT

The cutting blade for a juicer, comprising a central seat located at the center, wherein a cutting blade with a conical top is integrally extended from one end of the central seat, and a material pushing blade with a conical top is integrally and horizontally extended from the other end of the central seat; the central seat is in a cone; the angle of elevation of the cutting blade is within 36.5±10°; the angle of elevation of the material pushing blade is within 11±5°; and, the included angle between the cutting blade and the material pushing blade is within 146±20°. The fruit or vegetable to be cut can be unstable in gravity and thus be easy to enter the wall of a material storage bin, so that the extension intersection planes of the cutting position and the material pushing position can form a concave angle in a stereoscopic space.

This application claims priority to China Patent Application No. 202422764752.7 filed November 13, 2024, which is incorporated herein by reference in its entirety.

### TECHNICAL FIELD

The disclosure relates to the technical field of kitchenware manufacturing, in particular to a cutting blade for a juicer.

### BACKGROUND

Juicers are a kind of small household appliances that can quickly squeeze fruits or vegetables into fruit or vegetable juice. For most juicers, the fruit or vegetable is automatically cut into small pieces by the cutting tool in the material storage bin and then juiced by the spiral propeller in a low-speed rotation manner. The inherent taste and nutrition of fruits or vegetables will not be destroyed, and high juice yield, simple operation, time saving and long service life of the machine are achieved.

Chinese Patent Issuing (Publication) No. CN220192732U entitled JUICER HAVING MATERIAL STORAGE BIN WITH CUTTING FUNCTION. The following technical solution was disclosed: "[0006] In order to achieve the above purpose, the utility model designs a juicer having a material storage bin with a cutting function, including a material storage bin and a juice collection cup, wherein the juice collection cup is arranged below the material storage bin; a brush rack is disposed in the middle of the bottom of the material storage bin; a discharge port is provided on one side of the bottom of the material storage bin; a blocking plate that extends outward and is tilted toward the juice collection cup is provided on the side of the discharge port close to the center of the material storage bin; a U-shaped cutter is arranged below the material storage bin; a spiral juicing blade is arranged below the cutter; and, a juice outlet is formed outside the juice collection cup. When a food material is placed in the material storage bin, the food material is brushed into the discharge port by the brush rack, then enters the juice collection cup and is cut by the cutter, and then is further juiced by the spiral juicing blade, and the juice finally flows out from the juice outlet".

The following technical effects were achieved: "[0016] The utility model designs a juicer having a material storage bin with a cutting function... The food material will be cut by the cutter at the moment when it leaves the discharge port, so that the food material will be cut into small pieces by the cutter before entering the grinding part, facilitating subsequent grinding, reducing the amount of the food material that has not been cut and improving juicing efficiency. Meanwhile, the brush rack brushes the pieces of the food material into the discharge port for cutting, so that no residue remains in the material storage bin after the food material is cut. Particularly, the U-shaped cutter is adapted to the material storage bin with an inclined bottom, so that the food material is cut after a certain buffer, thus reducing the impact of the placement of the food material on the cutter, increasing the cutting surface and improving the cutting efficiency of the cutter".

In practical applications, the cutting tool in the material storage bin (also referred to as the cutting blade for the juicer) functions to automatically cut fruits or vegetables into small pieces, and the shape of the cutting tool will directly affect the cutting efficiency, so there is still room for further improvement.

### SUMMARY

Embodiments of the present is to provide a cutting blade for a juicer to solve the problems mentioned in the BACKGROUND.

To solve the above technical problem, the embodiments of the present is implemented by the following technical measures. A cutting blade for a juicer is provided, including a central seat located at the center, wherein a cutting blade with a conical top is integrally extended from one end of the central seat, and a material pushing blade with a conical top is integrally and horizontally extended from the other end of the central seat; the central seat is in a cone; the angle of elevation of the cutting blade is within 36.5±10°; the angle of elevation of the material pushing blade is within 11±5°; and, the included angle between the cutting blade and the material pushing blade is within 146±20°.

Compared with the prior art, the embodiments of the present has the following advantages. The angle of elevation of the cutting blade is within 36.5±10°, and the included angle between the cutting blade and the material pushing blade is within 146±20°.With this novel blade structure, the extension intersection planes of the cutting position and the material pushing position can form a concave angle in a stereoscopic space, so that the fruit or vegetable to be cut (e.g., an apple) can well enter this space, and the fruit or vegetable to be cut (e.g., an apple) is fixed to the bottom of the material storage bin and can be easily chopped by the blade.

The angle of elevation of the cutting blade is within 36.5±10°, and the angle of elevation of the material pushing blade is within 11±5°.With this novel blade structure, the cutting blade and the material pushing blade can form two oblique angles with the horizontal plane, so that the gravity of the fruit or vegetable to be cut (e.g., an apple) will be deflected inward, and the fruit or vegetable will not remain on the blade after being cut and will fall on the bottom of the material storage bin due to gravity deflection and be pushed to the feed port by the material pushing blade (next procedure).

Both the cutting blade and the material pushing blade have conical tops, and the central seat is in a cone. These novel structures can make fruits, vegetables or other circular food materials (e.g., an apple) unstable in gravity, so that the food material is easy to enter the cutting space formed by the wall of the material storage bin, the cutting blade and the material pushing blade. Thus, the cutting efficiency is improved.

As an improvement of the present, the cutting blade has a quadrilateral section, a rake face has an angle of C, and a flank face has an angle of D, where C＜D. The purpose of choosing this design is as follows: this novel structure can raise the cutting surface, thus improving the cutting efficiency and reducing the cutting resistance.

As an improvement of the present, material pushing cavities are uniformly provided on both sides of the material pushing blade. The purpose of choosing this design is as follows: small blocks or pieces of the fruit or vegetable (e.g., an apple) are allowed to be cut smaller under the blocking of the material pushing cavities.

As an improvement of the present, a balancing cavity is provided in the back of the cutting blade. The purpose of choosing this design is as follows: the cutting blade and the material pushing blade keep a dynamic balance during rotation and will not vibrate.

### BRIEF DESCRIPTION OF THE DRAWINGS

The above and/or additional aspects and advantages of the present disclosure would become apparent and easily understood from the following description of the embodiments in combination with the drawings, in which:

FIG. 1 is a first stereoscopic diagram of the cutting blade for a juicer according to the present disclosure.

FIG. 2 is a second stereoscopic diagram of the cutting blade for a juicer according to the present disclosure.

FIG. 3 is a six-view diagram of the cutting blade for a juicer according to the present disclosure.

FIG. 4 is a a front view of the cutting blade for a juicer according to the present disclosure.

FIG. 5 is a top view of the cutting blade for a juicer according to the present disclosure.

FIG. 6 is a sectional view along A-A according to the present disclosure.

in which: 1: central seat; 2: cutting blade; 3: material pushing blade; 4: cone; 5: material pushing cavities; 6: balancing cavity; 7: apple; 8: juicer wall; 9: conical top; 10: rake face; and, 11: flank face.

The disclosure will be further described by the following specific embodiments in combination with the accompanying drawings.

### DETAILED DESCRIPTION OF PREFERRED EMBODIMENTS

The preferred embodiments of the will be illustrated below with reference to the drawings. It should be understood that the preferred embodiments described herein are merely used for illustrating and explaining the embodiment of the present, rather than limiting the present.

### EMBODIMENT 1

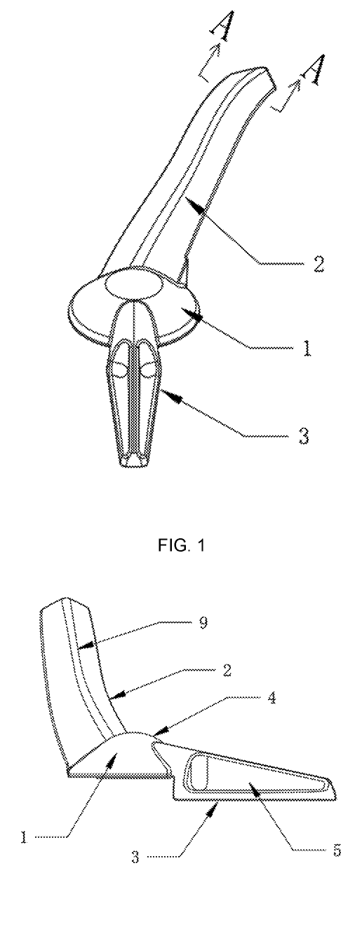

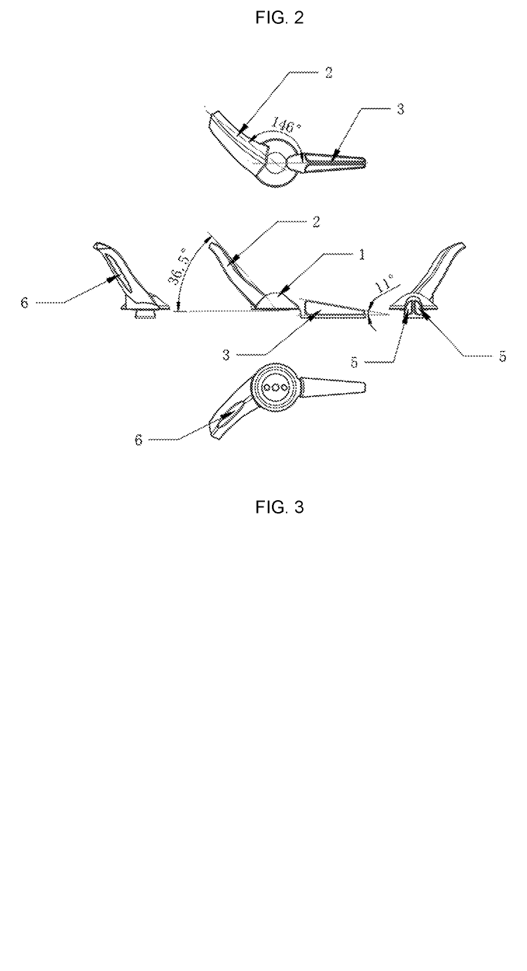

The reference is made to FIGS. 1-6.

The cutting blade for a juicer in this embodiment includes a central seat 1 located at the center. A cutting blade 2 with a conical top is integrally extended from one end of the central seat 1, and a material pushing blade 3 with a conical top 9 is integrally and horizontally extended from the other end of the central seat 1. The central seat 1 is a cone 4. Both the cutting blade 2 and the material pushing blade 3 have conical tops 9, and the central seat 4 is a cone 1. These steeple-crowned structures can make fruits, vegetables or other circular food materials (e.g., an apple 7) unstable in gravity, so that the food material is easy to enter the cutting space formed by the juicer wall 8 (also referred to as the wall of the material storage bin), the cutting blade 2 and the material pushing blade 3.

In an embodiment of the present the reference is made to FIG. 3. The angle of elevation of the cutting blade 2 (the included angle between the cutting blade 2 and the horizontal plane) is 36.5°, the angle of elevation of the material pushing blade 3 (the included angle between the material pushing blade 3 and the horizontal plane) is 11°, and the included angle between the cutting blade 2 and the material pushing blade 3 is 146°.

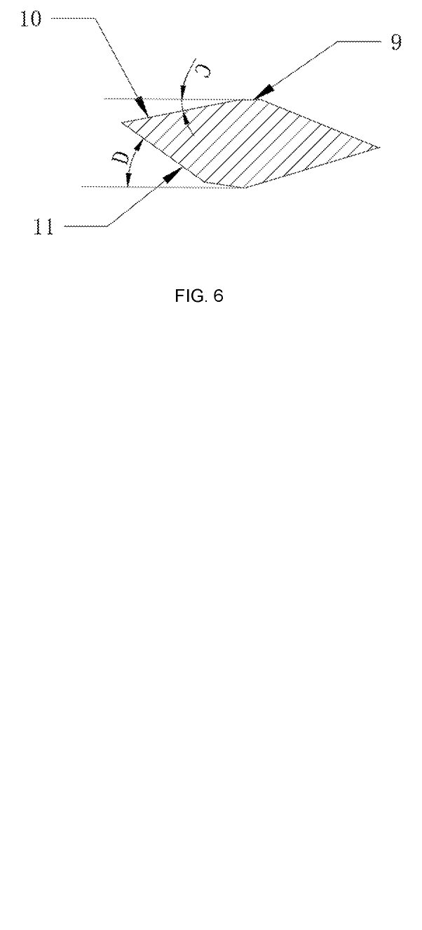

The angle of elevation of the cutting blade 2 is 36.5°, and the included angle between the cutting blade 2 and the material pushing blade 3 is 146°, referring to FIG. 5. With this novel blade structure, the extension intersection planes of the cutting position and the material pushing position can form a concave angle in a stereoscopic space, so that the fruit or vegetable to be cut (e.g., an apple 7) can well enter this space, and the fruit or vegetable to be cut (e.g., an apple 7) is fixed to the bottom of the material storage bin and can be easily chopped by the blade.

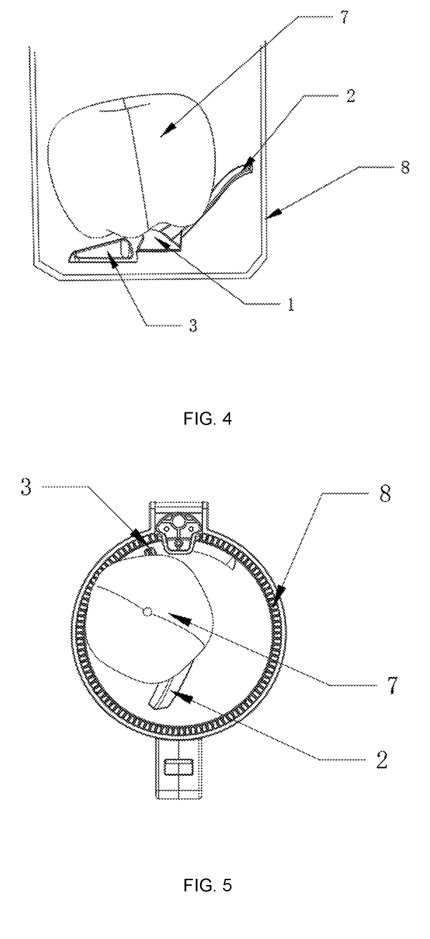

The angle of elevation of the cutting blade 2 is 36.5°, and the angle of elevation of the material pushing blade 3 is 11°, referring to FIG. 4.With this novel blade structure, the cutting blade 2 and the material pushing blade 3 can form two oblique angles with the horizontal plane, so that the gravity of the fruit or vegetable (e.g., an apple 7) will be deflected inward, and the fruit or vegetable will not remain on the blade after being cut and will fall on the bottom of the material storage bin due to gravity deflection and be pushed to the feed port by the material pushing blade 3 (next procedure).

In an embodiment of the present, the reference is made to FIG. 6. The cutting blade 2 has a quadrilateral section, a rake face 10 has an angle of C, and a flank face 11 has an angle of D, where C＜D. This novel structure can raise the cutting surface, thus improving the cutting efficiency and reducing the cutting resistance.

Further, material pushing cavities 5 are uniformly provided on both sides of the material pushing blade 3. By providing cavities on the flanks of the material pushing blade 3, small blocks or pieces of the fruit or vegetable (e.g., an angle 7) can be cut smaller under the blocking of the material pushing cavities 5.

Further, a balancing cavity 6 is provided in the back of the cutting blade 2. The purpose of choosing this design is as follows: the cutting blade 2 and the material pushing blade 3 keep a dynamic balance during rotation and will not vibrate.

The embodiment of the present has the following beneficial effects:

With this novel blade structure, the extension intersection planes of the cutting position and the material pushing position can form a concave angle in a stereoscopic space, so that the fruit or vegetable to be cut (e.g., an apple 7) can well enter this space, and the fruit or vegetable to be cut (e.g., an apple 7) is fixed to the bottom of the material storage bin and can be easily chopped by the blade.

With this novel blade structure, the cutting blade 2 and the material pushing blade 3 can form two oblique angles with the horizontal plane, so that the gravity of the fruit or vegetable (e.g., an apple 7) will be deflected inward, and the fruit or vegetable will not remain on the blade after being cut and will fall on the bottom of the material storage bin due to gravity deflection and be pushed to the feed port by the material pushing blade 3 (next procedure).

Both the cutting blade 2 and the material pushing blade 3 have conical tops 9, and the central seat 1 is in a cone 4. These novel structures can make fruits, vegetables or other circular food materials (e.g., an apple 7) unstable in gravity, so that the food material is easy to enter the cutting space formed by the wall of the material storage bin, the cutting blade 2 and the material pushing blade 3.

The cutting efficiency is improved through these improvements.

In the description of the embodiment of the present, it should be noted that the orientation or position relation indicated by terms "vertical", "upper", "lower", "horizontal" or the like is an orientation or position relation shown by the drawings, merely for describing the present utility model and simplifying the description rather than indicating or implying that the specified device or element must have a particular orientation or be constructed and operated in a particular orientation. Therefore, the terms should not be interpreted as limitations to the present utility model.

In the description of the embodiment of the present, it should also be noted that, unless otherwise expressly specified and defined, the terms "arrange", "mount", "link" and "connect" should be interpreted in a broad sense. For example, the connection may be fixed connection, detachable connection or integral connection; or, may be mechanical connection or electrical connection; or, may be direct connection or indirect connection through an intermediate medium; or, may be internal communication between two elements. A person of ordinary skill in the art can understand the specific meanings of the above terms in the present utility model according to specific conditions.

Finally, it should be noted that the foregoing description merely shows the preferred embodiments of the present and is not intended to limit the present. Although the embodiment of the present has been described in detail with reference to the above embodiments, those skilled in the art can still make modifications to the technical solutions recorded in the above embodiments or make equivalent replacements to some technical features. Any modifications, equivalent replacements and improvements made without departing from the spirit and principle of the present shall fall into the protection scope of the present.

What is claimed is:

1. A cutting blade for a juicer, comprising a central seat (1) located at the center, wherein a cutting blade (2) with a conical top (9) is integrally extended from one end of the central seat (1), and a material pushing blade (3) with a conical top (9) is integrally and horizontally extended from the other end of the central seat (1); the central seat (1) is in a cone (4); the angle of elevation of the cutting blade (2) is within 36.5±10°; the angle of elevation of the material pushing blade (3) is within 11±5°; and, the included angle between the cutting blade (2) and the material pushing blade (3) is within 146±20°.

2. The cutting blade for a juicer according to claim 1, wherein the cutting blade (2) has a quadrilateral section, a rake face (10) has an angle of C, and a flank face (11) has an angle of D, where C＜D.

3. The cutting blade for a juicer according to claim 1, wherein material pushing cavities (5) are uniformly provided on both sides of the material pushing blade (3).

4. The cutting blade for a juicer according to claim 1, wherein a balancing cavity (6) is provided in the back of the cutting blade (2).
